(19) United States
(12) Patent Application Publication
(10) Pub. No.: US 2022/0412859 A1
(43) Pub. Date: Dec. 29, 2022

(54) Sensing Array, System And Method For Ore Processing Equipment

(71) Applicant: Weir Surry Group, Inc., Madison, WI (US)

(72) Inventors: Ronald Joseph Bourgeois, Sun Prairie, WI (US); Randy James Kosmicki, Edgerton, WI (US); Roger Bradley Millington, Stukeley Meadows (GB); James Christopher Frake, Foxton (GB)

(21) Appl. No.: 17/771,646

(22) PCT Filed: Oct. 29, 2020
(86) PCT No.: PCT/AU2020/051167

§ 371 Date: Apr. 25, 2022

Related U.S. Application Data
(60) Provisional application No. 62/927,397, filed on Oct. 29, 2019.

(30) Foreign Application Priority Data
Feb. 7, 2020 (AU) 2020900343

(51) Int. Cl. G01N 3/56; F04D 7/04; F04D 15/00; H04Q 9/00; G06K 19/07; G06K 7/10

(52) U.S. Cl. CPC G01N 3/56; F04D 7/045; F04D 15/0088; H04Q 9/00; G06K 19/0723; G06K 7/10366; B02C 17/1805

(57) ABSTRACT

Described is a wear part for minerals processing equipment. The wear part comprises an inner surface for contact with slurry when the minerals processing equipment is in use and an outer surface of the wear part. The wear part further comprises at least one sacrificial wear sensor located at a predetermined distance between the inner surface and the outer surface, the at least one sacrificial wear sensor being arranged to wirelessly communicate with a remote wear monitoring unit.

### TECHNICAL FIELD

The present invention generally relates to a wear sensor and a method for detecting wear in mineral processing equipment, and more particularly to a method of estimating wear in a liner of the ore processing equipment.

### BACKGROUND

A slurry pump is a type of pump designed for pumping liquid containing solid particles. Variations in design and construction of the pump may occur to account for the various different types of slurry. Surry may vary in the concentration of solids particles, the size of solid particles, the shape of solid particles, and the composition of the solution suspending the particles. An example of a slurry pump is a centrifugal pump.

Due to the abrasive nature of the medium being pumped, such pumps experience a very high wear rate on their internal components, such as the main liner that houses the impeller and the side liners located on either side of the main liner. The side liners include a front sider liner that is located on the inlet side of the impeller and a rear side liner that is located on the opposing side of the impeller. In particular, the side liner located on the inlet side of the pump (which is also referred to a front side liner or a throatbush) and the main liner (which is also referred to as a volute) are both subjected to great deal of wear.

Knowledge of the thickness of the front side liner, back side liner and the main side liner is important for effective maintenance of the pump. Such information informs pump operators of the optimal time to replace the liners, as replacing them too early is financially undesirable and replacing them too late runs the risk of failure of the liner and damage to the impeller, casing and other components. However, accurately determining the thickness of the various liners is challenging due to their location within the thick outer casing of the pump. As such, it is common for pumps to be disassembled and visually inspected for wear, which is a time consuming and costly exercise.

In the past, ultrasonic sensors have been mounted on the outside of the outer pump casing, using magnets or other such devices to adhere the ultrasonic sensing device to the pump. Such devices may be placed around various locations on the exterior of the pump and wired together in order to communicate with one another. However, such solutions require the sensors to determine of the thickness of the internal components through various surfaces, such as the thick outer casing. The outer casing is designed to contain the high pressures generated during operation of the pump, but the thickness of the casing decreases the accuracy of external readings. Further, additional issues are encountered when measuring the thickness of a front side liner that is axially adjustable relative to the main liner.

Similar abrasion issues may occur for a grinding mill designed to grind ore from a determined feed size of the ore to a smaller product size of the ore. The grinding action takes place by tumbling a mixture of the ore and metal grinding balls in the cylindrical compartment of the mill and conveying the ore through the mill as a slurry through the addition of water. The slurry may vary in concentration of solid particles, size of solid particles, the shape of solid particles, and the composition of the solution suspending particles. An example of a grinding mill is a horizontal overflow ball mill.

Due to the impact generated by the tumbling grinding balls and the abrasive nature of the medium being ground, such mills experience a high wear rate on the internal shell lining, such as the mill shell liner plates positioned against the internal mill shell, mill shell lifters positioned axially along the length of the mill shell, and the feed and discharge liners and lifters positioned on the compartment feed and discharge heads. In particular, the mill shell lifters which create most of the tumbling action in the mill are subjected to a great deal of wear.

Knowledge of the thickness and height of the shell liners and lifters is important for effective maintenance of the grinding mill. Such information informs mill operators of an optimum time to replace liners, as replacing the liners too early is financially undesirable and replacing the liners too late runs a risk of failure of the liners and damage to the mill shell and shell heads. However, accurately determining a thickness of the various liners is challenging due to the liners being located within a steel fabricated mill shell with thick cast mill heads, all of which rotates during operation. As such, it is common for grinding mills to be stopped and the lining visually inspected for wear, which is a time consuming and costly exercise.

The preferred embodiments of the present invention seek to address one or more of these disadvantages, and/or to at least provide the public with a useful alternative.

The reference in this specification to any prior publication (or information derived from the prior publication), or to any matter which is known, is not, and should not be taken as an acknowledgment or admission or any form of suggestion that the prior publication (or information derived from the prior publication) or known matter forms liner of the common general knowledge in the field of endeavour to which this specification relates.

### SUMMARY

This Summary is provided to introduce a selection of concepts in a simplified form that are further described below in the Detailed Description. This Summary is not intended to identify essential features of the claimed subject matter, nor is it intended to be used to limit the scope of the claimed subject matter.

In a first embodiment, there is provided by way of example a wear part for minerals processing equipment, the wear part comprising: an inner surface for contact with slurry when the minerals processing equipment is in use; an outer surface of the wear part; and at least one sacrificial wear sensor located at a predetermined distance between the inner surface and the outer surface, the at least one sacrificial wear sensor being arranged to wirelessly communicate with a remote wear monitoring unit

In one embodiment the wear part is a pump liner for a centrifugal slurry pump.

In one embodiment the wear part is a lifter bar for a mill.

In one embodiment the at least one sacrificial wear sensor is injected into the wear part.

In one embodiment the at least one sacrificial wear sensor is injected into the wear part at the predetermined distance between the inner surface and the outer surface.

In one embodiment the wear monitoring unit is connected to an antenna and the at least one sacrificial wear sensor wirelessly communicates with the wear monitoring unit via the antenna.

In one embodiment the at least one wear sensor is two wear sensors and the two wear sensors are in line from the antenna and configured to operate at identifiably different frequencies from each other.

In one embodiment the at least one wear sensor is integrated into material of the wear part.

In one embodiment the at least one sacrificial wear sensor indicates wear to the predetermined depth when the at least one sacrificial wear sensor is nonresponsive to the wear monitoring unit.

In one embodiment the at least one sacrificial wear sensor is nonresponsive to the wear monitoring unit when the at least one sacrificial wear sensor and surrounding material of the wear part is worn away.

In one embodiment the pump liner is a liner selected from the set of a front side liner, a back side liner and a main liner.

In one embodiment the pump liner is a main liner of the centrifugal pump and is a volute having a main chamber for housing an impeller.

In one embodiment the main liner further comprises: an opening for inlet of the slurry into the main chamber; and a discharge outlet extending from the main pumping chamber for exit of the slurry from the main chamber.

In one embodiment the at least one wear sensor is located near a cutwater.

In one embodiment the outer surface of the liner is adapted to mate with the outer casing of the slurry pump.

In one embodiment the wear part further comprises: an additional sacrificial wear sensor located at a further predetermined distance between the inner surface and the outer surface and able to communicate with a wear monitoring unit.

In one embodiment the further predetermined distance of the additional sacrificial wear sensor is different to the predetermined distance of the at least one sacrificial wear sensor.

In one embodiment the wireless connection uses a low frequency (LF) radio frequency identification (RFID).

In one embodiment, there is provided by way of example a method of estimating wear in a wear part of minerals processing equipment, the method comprising: determining, via a wear monitoring unit, an operational status of at least one sacrificial wear sensor located in the wear part at a predetermined distance between an inner surface and an outer surface of the wear part, the at least one sacrificial wear sensor wirelessly communicating with the wear monitoring unit; and estimating wear in the wear part according to the determined operational status of the at least one sacrificial wear sensor.

In one embodiment the at least one sacrificial wear sensor is injected into the wear part.

In one embodiment the at least one sacrificial wear sensor is injected into the wear part at the predetermined distance between the inner surface and the outer surface.

In one embodiment the wear monitoring unit is connected to an antenna and the at least one sacrificial wear sensor wirelessly communicates with the wear monitoring unit via the antenna.

In one embodiment the at least one wear sensor is two wear sensors and the two wear sensors are in line from the antenna and configured to operate at identifiably different frequencies from each other.

In one embodiment the at least one wear sensor is integrated into material of the wear part.

In one embodiment a nonresponsive status of the operational status indicates wear of the wear part to at least the predetermined distance between the inner and the outer surface of the wear part.

In one embodiment the method further comprises: determining, via a wear monitoring unit, an operational status of an additional sacrificial wear sensor located at a further predetermined distance between the inner surface and the outer surface, the further predetermined distance being different to the predetermined distance of the at least one sacrificial wear sensor.

In one embodiment the wear in the wear part is estimated according to an operational status of the additional sacrificial wear sensor.

In one embodiment the wear in the wear part is estimated according to a wear distance selected from the set of the predetermined distance of the at least one sacrificial wear sensor and the further predetermined distance of the additional sacrificial wear sensor according to the operational status of the at least one sacrificial wear sensor and the additional sacrificial wear sensor.

In one embodiment the at least one sacrificial wear sensor and the additional sacrificial wear sensor are RFID transducers with spatial separation to reduce interference between each sensor.

In one embodiment the wear part is a pump liner for a centrifugal slurry pump.

In one embodiment the wear part is a lifter bar for a mill.

In one embodiment, there is provided by way of example a system for determining wear of a wear part for minerals processing equipment, the system comprising: at least one sacrificial wear sensor located at a predetermined distance between an inner surface and an outer surface of the wear part; and a wear monitoring unit adapted to wirelessly communicate with the at least one sacrificial wear sensor for determining wear of the wear part from an operational status of the at least one sacrificial wear sensor.

In one embodiment the operational status determines wear to the predetermined depth when the at least one sacrificial wear sensor is nonresponsive to the wear monitoring unit.

In one embodiment the wear part is a pump liner for a centrifugal slurry pump.

In one embodiment the pump liner is a liner selected from the set of a front side liner, a back side liner and a main liner.

In one embodiment the system further comprises: an additional sacrificial wear sensor located at a further predetermined distance between the inner surface and the outer surface and able to communicate with a wear monitoring unit.

In one embodiment the further predetermined distance of the additional sacrificial wear sensor is different to the predetermined distance of the at least one sacrificial wear sensor.

In one embodiment the wear part is a lifter bar for a mill.

In one embodiment the at least one sacrificial wear sensor is injected into the wear part.

In one embodiment the at least one sacrificial wear sensor is injected into the wear part at the predetermined distance between the inner surface and the outer surface.

In one embodiment the wear monitoring unit is connected to an antenna and the at least one sacrificial wear sensor wirelessly communicates with the wear monitoring unit via the antenna.

In one embodiment the at least one wear sensor is two wear sensors and the two wear sensors are in line from the antenna and configured to operate at identifiably different frequencies from each other.

In one embodiment wherein the at least one wear sensor is integrated into material of the wear part.

### BRIEF DESCRIPTION OF FIGURES

Example embodiments are apparent from the following description, which is given by way of example only, of at least one non-limiting embodiment, described in connection with the accompanying figures.

FIG. 1 illustrates a cross section view of a wear sensing system in accordance with an embodiment of the present invention;

FIG. 2 illustrates a perspective view of an example main liner in accordance with an embodiment of the present invention;

FIG. 3 illustrates a perspective view of an example main liner in accordance with an embodiment of the present invention;

FIG. 4 illustrates a side view of an example front side liner in accordance with an embodiment of the present invention;

FIG. 5A, illustrates a perspective view of an example front side liner in accordance with an embodiment of the present invention;

FIGS. 5B and 5C each illustrate a perspective view of an example suction cover in accordance with an embodiment of the present invention;

FIGS. 5D, 5E and 5F respectively illustrate a cutaway view of the example front side liner and suction cover in accordance with an embodiment of the present invention;

FIG. 6 illustrates a functional block diagram of an example processing system that can be utilised to embody or give effect to a particular embodiment;

FIG. 7 illustrates an example network infrastructure that can be utilised to embody or give effect to a particular embodiment;

FIGS. 8A and 8B respectively illustrate an isometric cutaway of the wear sensing system in accordance with an embodiment of the present invention;

FIG. 8C illustrates a view of an outer casing in accordance with an embodiment of the present invention;

FIG. 9A illustrates a sectional view of the wear sensing system in accordance with an embodiment of the present invention;

FIG. 9B illustrates a plan view of an antenna of the wear sensing system in accordance with an embodiment of the present invention;

FIG. 10 illustrates a flow diagram of a method of monitoring wear using the wear sensing system in accordance with an embodiments of the present invention.

FIGS. 11A, 11B and 11C respectively illustrate a side view, bottom perspective view and top perspective view of a wear monitoring unit in accordance with an embodiment of the present invention;

FIG. 12 illustrates an exploded section view of a wear monitoring unit in accordance with an embodiment of the present invention;

FIG. 13 illustrates an exploded view of a wear monitoring unit in accordance with an embodiment of the present invention;

FIG. 14 illustrates a lifter bar attached to a mill shell accordance with one embodiment of the present invention;

FIG. 15 illustrates a cross section of the lifter bar of FIG. 14 attached to the mill shell;

FIG. 16 illustrates an isometric cross section of the lifter bar of FIG. 14 attached to the mill shell;

FIG. 17 illustrates a mounting bar of the lifter bar of FIG. 14;

FIG. 18 illustrates an antenna used with the lifter bar of FIG. 14; and

FIG. 19 illustrates a vented lifter liner bolt used with the lifter bar of FIG. 14.

### DETAILED DESCRIPTION

The following modes, given by way of example only, are described in order to provide a more precise understanding of one or more embodiments. In the figures, like reference numerals are used to identify like parts throughout the figures.

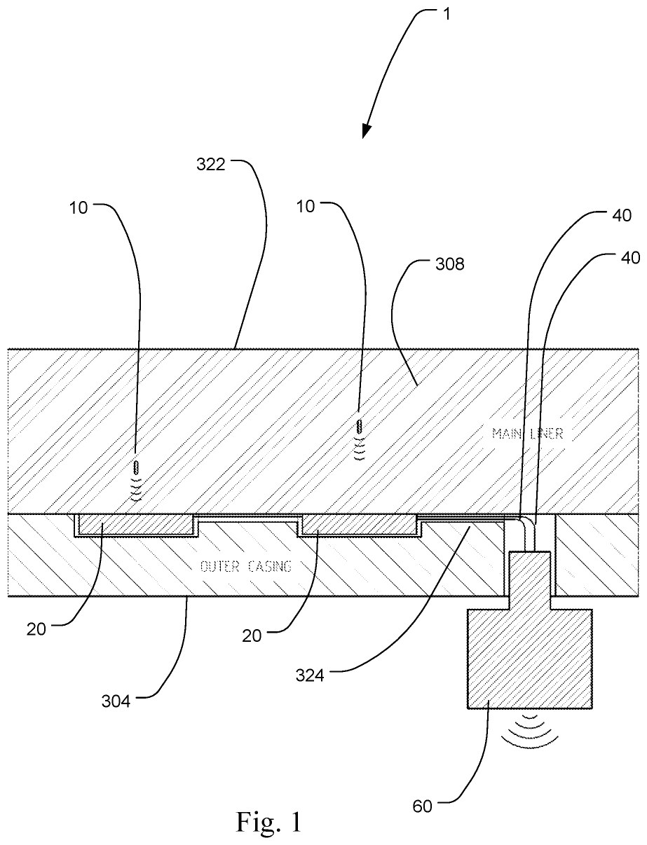

With general reference to FIGS. 1 to 5F, an embodiment is described in relation to a centrifugal slurry pump referred hereafter as “the pump”. The pump may be lined. That is, a lined pump includes internal wearing liners. These wearing liners operate as wear parts and are described in further detail below.

A general description of a lined pump is provided as follows. The pump may include an outer casing which provides an outer housing for the internal components of the pump. The outer casing may be formed from cast or ductile iron. The pump may be supported by a pedestal or base that is attached to the outer casing. The outer casing may be formed from two side casing parts or halves (sometimes also known as the frame plate and the cover plate) which are joined together about the periphery of the two side casings parts.

The pump is formed with an inlet hole and an outlet hole. When in use, for example in a process plant, the pump is connected by piping to the inlet hole and to the outlet hole, for example to facilitate pumping of a mineral slurry.

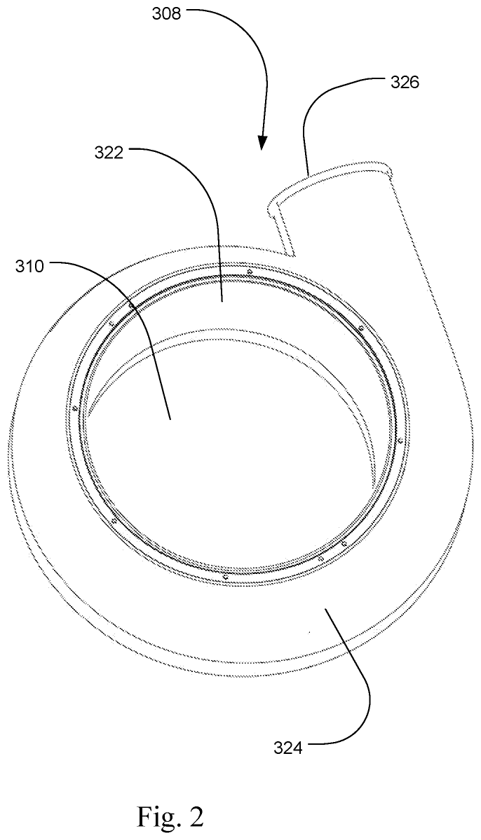

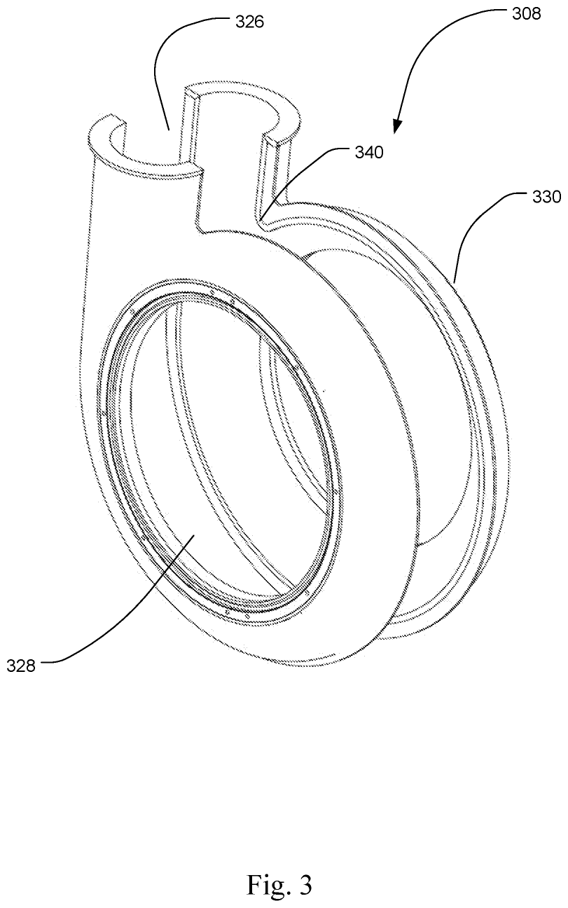

The pump may include one or more pump liners, such as a side liner and a main liner housed within the outer casing of the pump. More particularly, the outer casing may house a main liner (or volute) and two side liners. The main liner may be formed with an outer surface that is adapted to mate with the outer casing. An example of a main liner 308 is provided in FIGS. 2 and 3. The main liner 308 further defines a pump chamber 310 in which an impeller (not shown) is positioned for rotation. The impeller is attached to a drive shaft rotated by a motor. The drive shaft drives the impeller to rotate about an axis within the pump chamber 310. Also shown is an inner surface 322 of the main liner 308 and an outer surface 324 of the main liner 308. The main liner 308 has two generally circular openings 328 and 330 located on either side. The inlet hole 328 allows a fluid to enter the pump chamber 310, typically via a side liner as further discussed below, whilst the other opening 330 allows for the introduction of the drive shaft for driving the impeller in the pump chamber 310. The main liner further includes an outlet hole 326, which provides an exit for the fluid from the pump chamber 310.

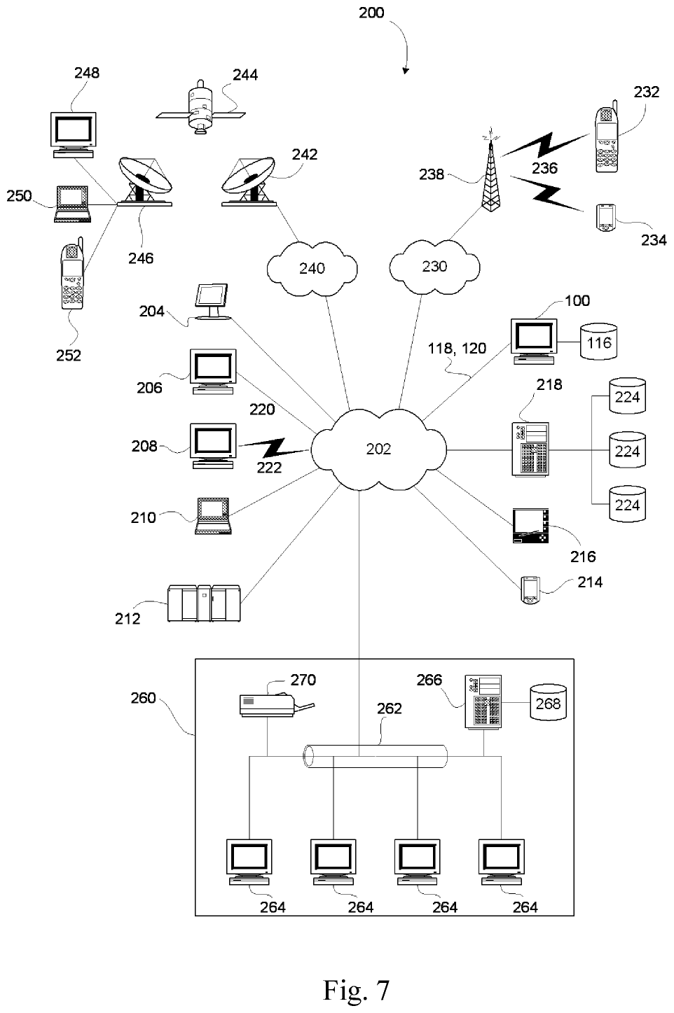

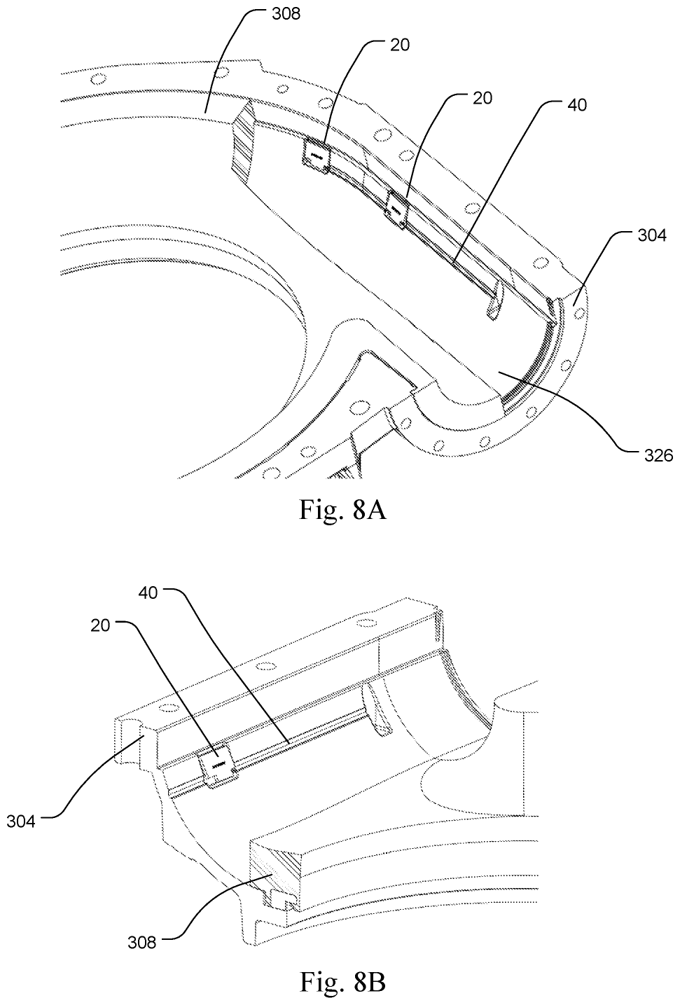

The main liner 308 may be a one-piece liner. Alternatively, the main liner may consist of two or more pieces that are attached together. An example of one-half of a two-piece main liner is shown in FIG. 8, while FIG. 3 shows both pieces of a two-part main liner. Another alternative may have the main liner and the outer casing formed together as a single part, instead of as two separate parts.

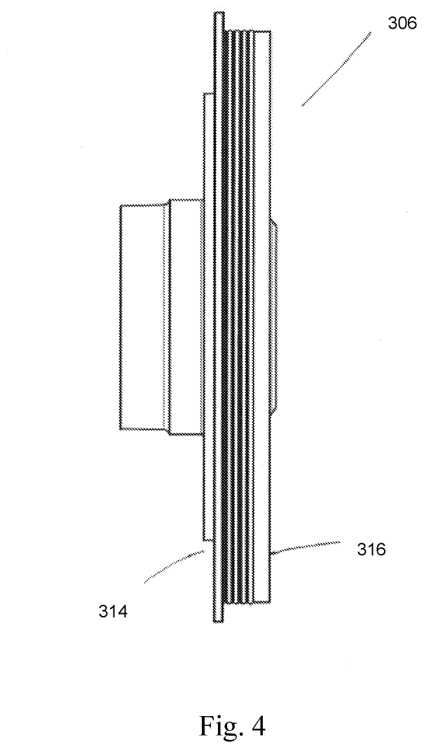

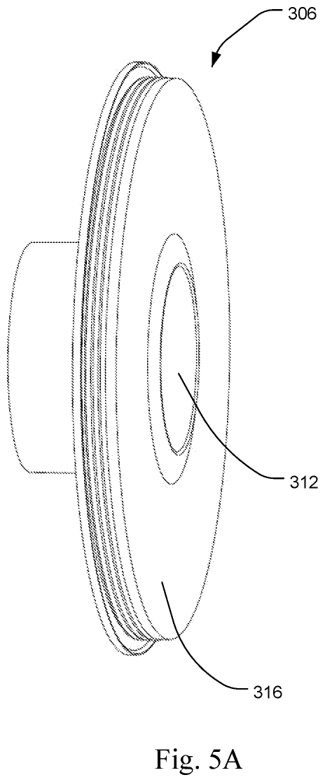

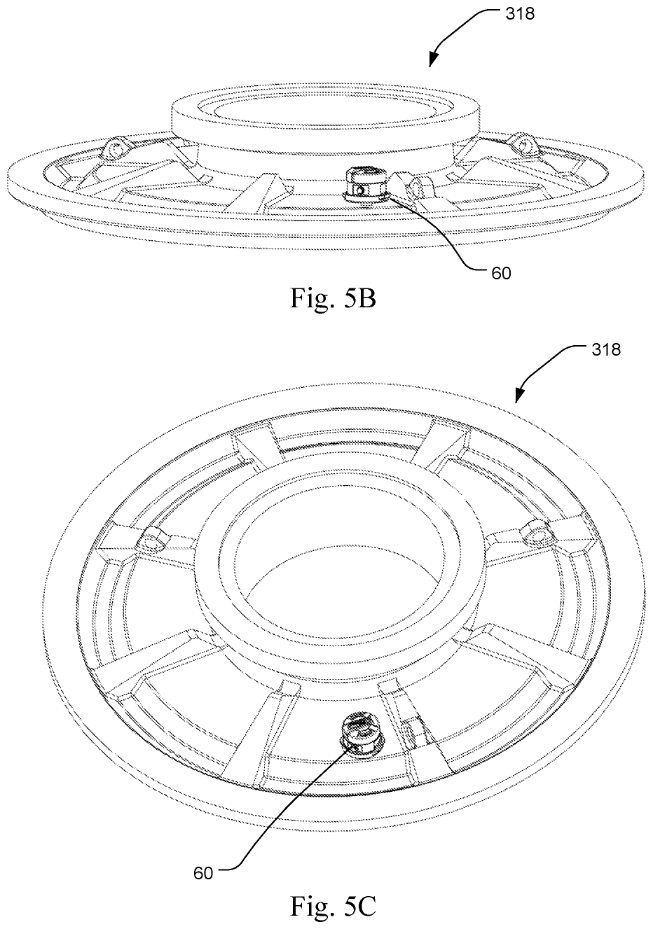

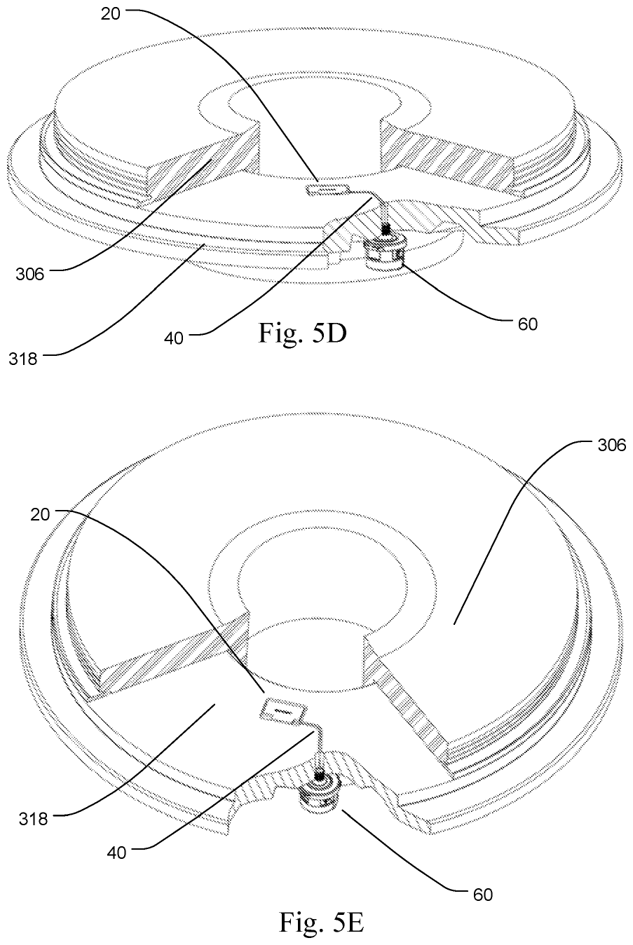

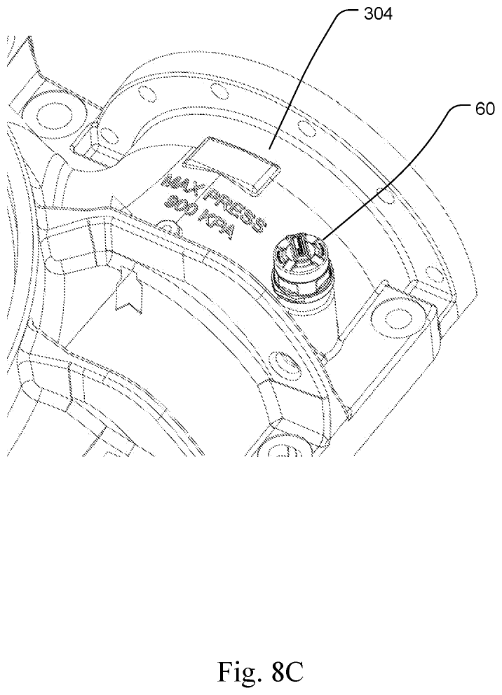

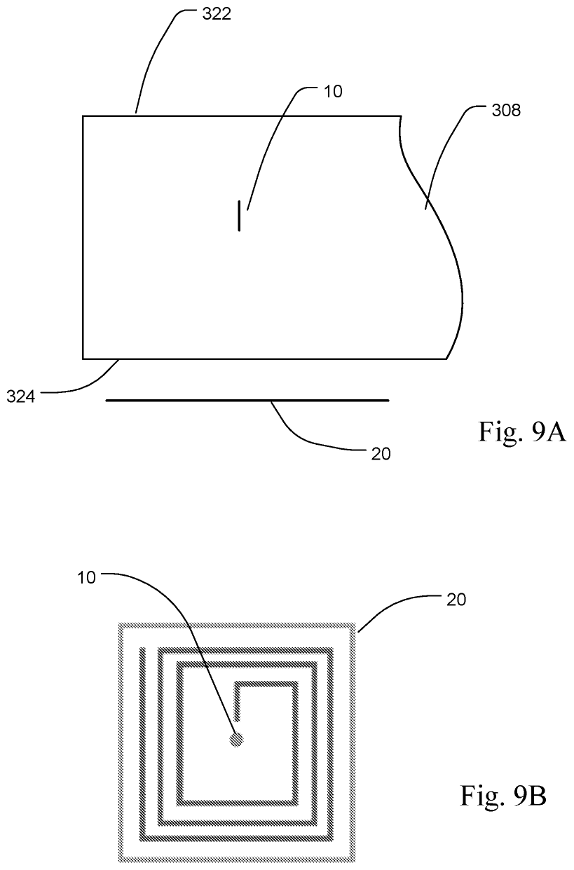

The outer casing also houses the two side liners, the first being the rear side liner (also known as the back liner), which is located nearer the rear end of the pump (that is, nearest to the pedestal or base). The other side liner is a front side liner 306 (also known as a front liner or throatbush), which is located nearer the front end of the pump and proximate to the inlet hole or suction side of the pump. Accordingly, the front side liner 306 on the suction side of the pump is provided with an aperture 312 to accommodate the inlet hole 328. An example of a front side liner 306 is provided in FIGS. 4 and 5A. The front side liner 306 may further comprise a front face 316 and a rear face 314, the front face 316 is arranged to face the impeller housed within the main liner 308, and the rear face 314 is arranged to face a suction casing 318. The suction casing 318, as shown in FIGS. 5B to 5F, may have a wear monitoring unit 60 attached on an external side, near the front end of the pump. Further, one or more antenna modules 20, hereafter referred to as “antenna modules”, may be located in the suction cover 318 with antenna wires 40 leading to the wear monitoring unit 60. In one embodiment, not illustrated, the antenna modules 20 may be located within reinforcing of the front side liner 306 at the rear face 314. Wear sensors 10 are located in the front side liner 306 and are best shown by FIGS. 9A and 9B. It is understood by the person skilled in the art that any general reference within the specification to “a pump liner” may refer to any one or more of a front side liner, a back side liner and a main liner.

In one embodiment, a wear sensing system 1 is provided with reference to FIG. 1. The wear sensing system 1 includes at least one sacrificial wear sensor 10 to determine an amount of wear in the pump liner. Within the context of the specification, the term “sacrificial” refers to the intentional loss or destruction of an item for the sake of other considerations or objectives. For convenience, the “at least one sacrificial wear sensor” is hereafter referred to as the “wear sensor”. Each wear sensor 10 may be positioned at a predetermined distance between the inner surface and the outer surface of the pump liner. The wear sensor 10 is able to communicate with the wear monitoring unit 60, via the antenna module 20, typically using wireless communication. Information about the amount or level of wear experienced by the pump liner is provided by a response of the wear monitor 60. If the wear sensor 10 responds to the communication from the wear monitoring unit 60, then the pump liner has not worn to the predetermined distance between the inner and outer surface of the pump liner where the wear sensor 10 is located. However, if the wear sensor 10 is nonresponsive to communication from the wear monitoring unit, then this is an indication that the pump liner has worn to at least the predetermined depth. A nonresponsive wear sensor 10 is one that is considered to be damaged, non-operational or destroyed from being worn away along with the surrounding pump liner material.

For example, where the pump liner shown in FIG. 1 is a main liner 308, said main liner 308 is embedded with two wear sensors 10. Each of the wear sensors 10 may include a transducer positioned in the main liner 308 at a pre-set depth from the inner surface 322. The pre-set depth is determined by the predetermined distance of the wear sensor 10 between the inner surface 322 and the outer surface 324. The wear sensors 10 may be embedded into the main liner 308 in a manner dependent on the material of the main liner 308. For example, if the main liner 308 is made of an elastomer material then the wear sensor 10 may be injected from either the outer surface 324 or the inner surface 322. Alternatively, the wear sensor 10 may be embedded in the main liner 308 during the forming process.

In an embodiment, the wear sensor 10 may be a passive low frequency radio frequency identification (RFID) transponder that transmits a response signal in reply to a signal transmitted by the antenna module 20. Wear of the main liner 308 is measured or indicated when the wear sensor 10 does not respond to the signal sent from the antenna module 20. In an embodiment, the amount of wear may be determined by the pre-set depth of the wear module 10. The use of a passive RFID transponder may be advantageous due to a reduced size compared to an active RFID tag as there is no need for a power source. However, it is within the purview of the skilled addressee that active RFID tags may also be used, as well as other short range wireless communication systems. Alternatively, high frequency radio frequency identification tags may also be used.

In a further embodiment, the wear sensors 10 may be placed at monitoring locations in the main liner 308 that are expected to have a higher wear rate during operation of the pump. Examples of such locations are a cutwater 340 of the main liner 308 or regions of the side liners near the cutwater 340. Each monitoring location may have one or more wear sensors 10. If there is more than one wear sensor placed at the monitoring location, then the additional wear sensors may provide redundancy, may be used to determine different amounts of wear, or a combination of the two. To determine different amounts of wear at the monitoring location, the wear sensors 10 are placed at different pre-set depths. An initial amount of wear is detected when the wear sensor 10 closest to the inner surface 322 does not respond to a signal from the antenna module 20. As such, wear sensors 10 located with increasing pre-set depths provide a measure of increasing wear of the pump liners at the monitoring location.

In an embodiment, each wear sensor 10 corresponds to a respective antenna module 20, which is described in more detail below in relation to FIGS. 9A and 9B. The wear sensor 10 is located proximate to the antenna module 20, where a spacing between the wear sensors 10 provides suitable spatial separation to prevent interference between each pair of wear sensor 10 and antenna module 20. While FIG. 1 illustrates an embodiment where each wear sensor 10 communicates with a corresponding antenna module 20, an alternate embodiment may include two or more wear sensors 10 being arranged to correspond to a single antenna module 20. That is two or more wear sensors 10 may be arranged to transmit a signal to and receive a response signal from a single antenna module 20. In such an arrangement, each wear sensor 10 may have a suitable identification code to allow individual wear sensors 10 to be identified or operate at different frequencies.

The antenna modules 20 may be embedded within the outer surface 324 of the main liner 308. Alternatively the antenna modules 20 may be attached or adjacent to the outer surface 324 and positioned within matching recesses of an outer casing 304, as shown in FIG. 1, or placed within the outer casing 304 at locations suitable to read the wear sensors 10.

The antenna modules 20 may be connected to an antenna hub (not shown) by antenna wires 40 or connect to the wear monitoring unit 60 directly. The antenna wires 40 may be embedded into the outer surface 324 of the main liner 308. Alternatively, they may be arranged to be received within appropriately shaped and sized channels on the surface of the outer casing 304. The antenna modules 20 and the wear monitoring unit 60 may also communicate wirelessly, without the need for antenna wires 40. The antenna hub, if used, may provide a central location for connection of the antenna modules 20 to the wear monitoring unit 60. The wear monitoring unit 60 is a data transfer hub that controls the antenna modules 20. A multiplexer within the monitoring unit 60 may be used to select which wear sensor 10 will be read via the corresponding antenna module 20. In this way, the wear monitoring unit 60 may check the status of more than one wear sensor 10. Alternatively, the wear monitoring unit 60 and the antenna module 20 may be combined into a single unit.

Once the status of the wear sensors 10 has been determined by the wear monitoring unit 60, this information may be displayed to maintenance staff or pump operators. The wear monitoring unit 60 may have a local status display to display the amount of wear to the main liner 308. The local status display may include indicator lights to provide simple wear indication. Alternatively or additionally, the local status display may provide more information via a display screen. If the wear monitoring unit 60 is battery powered then the local status display may be activated by a button when checking is required.

Referring now to FIGS. 8A to 8C, an embodiment is illustrated by a cutaway view showing the antenna modules 20 and the antenna wires 40 mounted in the outer casing 306 and located adjacent to the main liner 308. As shown, the wear monitoring unit 60 is located on the outer casing 304, which provides a convenient location for maintenance access.

While the embodiments of FIGS. 1 and 8 are shown with respect to the main liner 308, the wear sensing system 1 may also be used on other pump liners such as the front side liner 306 and the back side liner. Further, while the embodiments described generally relate to a main liner, the described embodiments may also be practiced on the front side liner 306 and the back side liner. As would be appreciated by the person skilled in the art, the wear sensing system 1 may also be applied to wear parts for minerals processing and slurry handling equipment more generally. Such equipment includes pump liners for centrifugal pump, cyclone liners and lifter bars for mills.

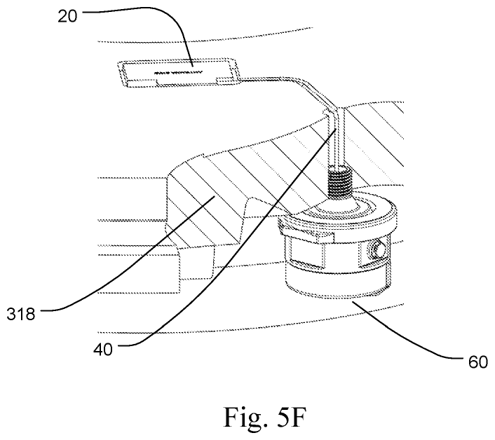

A particular embodiment of the present invention may be realised using a processing system, an example of which is shown in FIG. 6. The processing system 100 may be configured to operate as the wear monitoring unit 60 and may be implemented as a microcontroller. The processing system 100 generally includes at least one processor 102, or processing unit or plurality of processors, memory 104, at least one input device 106 and at least one output device 108, coupled together via a bus or group of buses 110. In certain embodiments, input device 106 and output device 108 may be the same device. An interface 112 may also be provided for coupling the processing system 100 to one or more peripheral devices, for example interface 112 could be a PCI card or PC card. At least one storage device 114, which houses at least one database 116, may also be provided. The memory 104 may be any form of memory device, for example, volatile or non-volatile memory, solid state storage devices, magnetic devices, etc. The processor 102 may include more than one distinct processing device, for example to handle different functions within the processing system 100.

Input device 106 receives input data 118, which may come from a variety of sources. For example, a keyboard, a pointer device such as a pen-like device or a mouse, audio receiving device for voice controlled activation such as a microphone, data receiver or antenna such as a modem or wireless data adaptor, data acquisition card, etc. Input data 118 may come from different sources, for example keyboard instructions in conjunction with data received via a network. The output device 108 produces or generates output data 120, which may include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 may be distinct and derived from different output devices, for example a visual display on a monitor in conjunction with data transmitted to a network. A user may view data output, or an interpretation of the data output, on, for example, a monitor or using a printer. The storage device 114 may be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116. The interface 112 may allow wired and/or wireless communication between the processing unit 102 and peripheral components that may serve a specialised purpose. The processor 102 receives instructions as input data 118 via input device 106 and may display processed results or other output to a user by utilising output device 108. More than one input device 106 and/or output device 108 may be provided. It would be appreciated by the skilled addressee that the processing system 100 may be any form of terminal, server, specialised hardware, or the like.

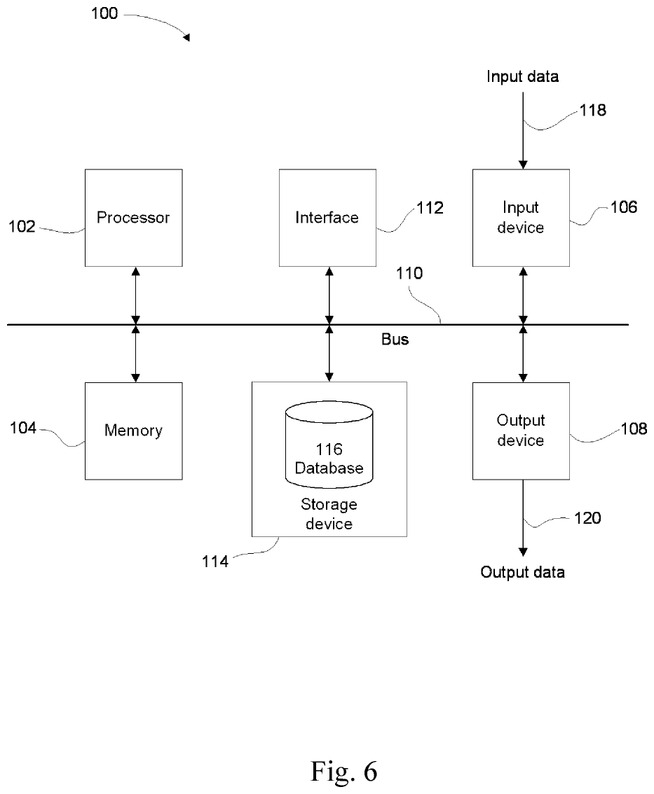

The processing system 100 may be a part of a networked communications system 200, as shown in FIG. 7. The processing system 100 may connect to network 202, for example, via the Internet or a WAN. Input data 118 and output data 120 may be communicated to other devices via network 202. Other terminals, for example, thin client 204, further processing systems 206 and 208, notebook computer 210, mainframe computer 212, PDA 214, pen-based computer 216, server 218, etc., may be connected to network 202. A large variety of other types of terminals or configurations may also be utilised. The transfer of information and/or data over network 202 may be achieved using wired communications means 220 or wireless communications means 222. Server 218 may facilitate the transfer of data between network 202 and one or more databases 224. Server 218 and one or more databases 224 provide an example of an information source.

Other networks may communicate with network 202. For example, telecommunications network 230 may be arranged to facilitate the transfer of data between network 202 and mobile or cellular telephone 232 or a PDA-type device 234, by utilising wireless communication means 236 and receiving/transmitting station 238. Satellite communications network 240 may communicate with satellite signal receiver 242 which receives data signals from satellite 244 which in turn is in remote communication with satellite signal transmitter 246. Terminals, for example further processing system 248, notebook computer 250 or satellite telephone 252, may thereby communicate with network 202. A local network 260, which for example may be a private network, LAN, etc., may also be connected to network 202. For example, network 202 could be connected with Ethernet 262 which connects terminals 264, server 266 which controls the transfer of data to and/or from database 268, and printer 270. Various other types of networks could be utilised.

The processing system 100 may be adapted to communicate with other terminals, for example further processing systems 206, 208, by sending and receiving data, 118, 120, to and from the network 202, thereby facilitating possible communication with other components of the networked communications system 200.

Thus, for example, the networks 202, 230, 240 may form part of, or be connected to, the Internet, in which case, the terminals 206, 212, 218, for example, may be web servers, Internet terminals or the like. The networks 202, 230, 240, 260 may be or form part of other communication networks, such as LAN, WAN, Ethernet, token ring, FDDI ring, star, etc., networks, or mobile telephone networks, such as GSM, CDMA or 3G, etc., networks, and may be wholly or partially wired, including for example optical fibre, or wireless networks, depending on a particular implementation.

The processing system 100 described above may be configured or arranged to operate as the wear sensor 60. In such an arrangement, the input data 118 and output data 120 may be used to communicate with the antenna module 20 to check the presence or status of the wear sensor 10 via the antenna module 20. Further, the processing system 100 may additionally include a short distance wireless communications system, such as but not limited to Bluetooth or Bluetooth Low Energy. Such a communication system may allow the wear sensor 60 to connect and communicate to a local device such as a mobile phone, tablet or computer. The local device may be configured to provide further information about the amount of wear to a user of the local device. Such information may include any one or more of a status of each the wear sensors 10, a time of last response for each of the wear sensors 10 and a status of any wear alarms. The local device may also allow configuration of the wear sensor 60 by the user via the wireless communication system. For example, the user may be able to alter how often each of the wear sensors 10 are tested for non-responsiveness.

Referring again to FIGS. 9A and 9B, an example arrangement of the antenna module 20 and the wear sensor 10 is described. FIG. 9A shows the wear sensor 10 embedded in a section of the main liner 308. The wear sensor 10 may be positioned between the inner surface 322 and the outer surface 324. The depth of the wear sensor 10 in said position is a measure of the distance from the inner surface 322 and the wear sensor 10. The antenna module 20 is shown with a gap to the outer surface 324. Alternatively, the antenna module 20 may be embedded in the outer surface 324 to maintain alignment with the wear sensor 10.

FIG. 9B illustrates an example position of the wear sensor 10 in relation to the antenna module 20. The wear sensor may be located in the middle of the antenna module 20, as such an arrangement will provide efficient operation of the wear sensor 10. Alignment between the wear sensor 10 and the antenna module 20 is required to enable operation of the wear sensor 10. If the wear sensor is out of alignment with the antenna module 20, then the wear sensor may not be able to respond effectively.

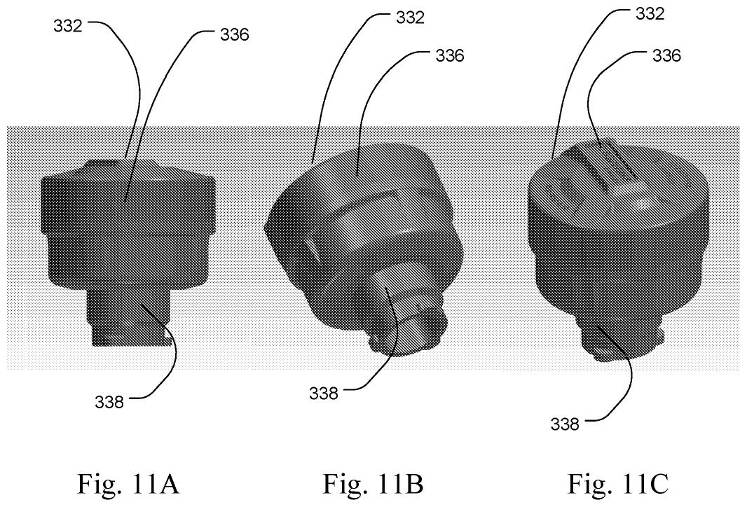

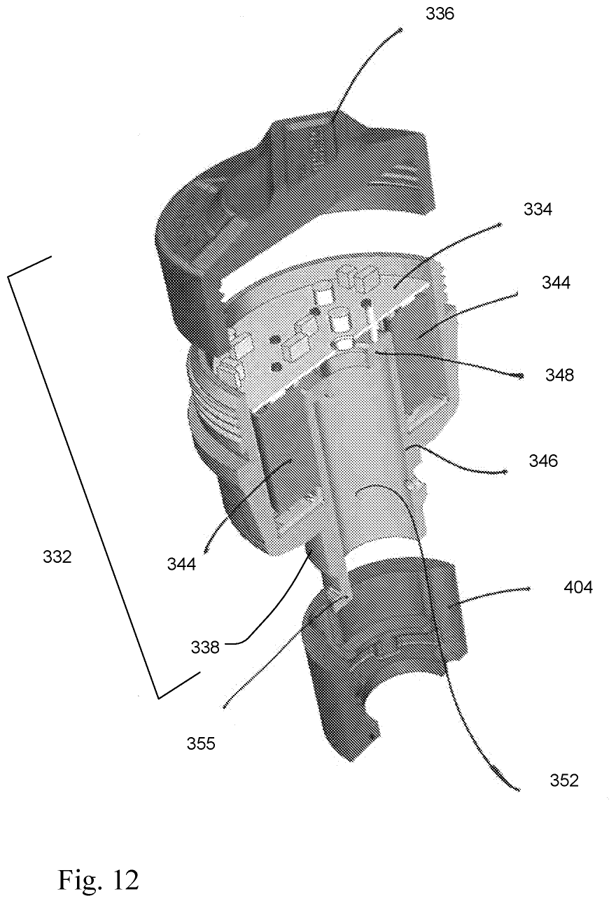

Referring to FIGS. 11A to 11C, the wear monitoring unit 60 may be arranged to house a processing module 334, as best shown in FIG. 12. The wear monitoring unit 60 may be arranged to align with, or locate outside, the surface of the outer casing 304. For example, as seen in FIG. 1, the wear monitoring unit 60 may be arranged to extend through the entirety of and protrude past the surface of the outer casing 304. Alternatively, the wear monitoring unit 60 may be arranged to sit within a recess formed within the outer surface of the outer casing 304 (not shown) such that the wear monitoring unit 60 sits flush with respect to the outer surface of the outer casing 304. By locating at least part of the wear monitoring unit 60 outside the thick outer casing 304 or in line with outer casing 304, the wear monitoring unit 60 is able to wirelessly communicate data collected by the wear sensor 10 to the local device or devices.

In an embodiment, the wear monitoring unit 60 may include a head portion 332 and a cap portion 336. The head portion 332 may further include a neck portion 338. The cap portion 336 may be removably connectable to the head portion 332, such that the connection between the cap portion 336 and the head portion 332 forms a watertight seal that prevents water and other contaminants like dirt, mud or oil from penetrating into the wear monitoring unit 60. The cap portion 336 may connect to the head portion 332 by means of a screw connection facilitated by a mating thread provided to an outer rim of the head portion 332 and the inner rim of the cap portion 336. Alternatively, the cap portion 336 may connect to the head portion 332 by means of a snap fit connection. Therefore, in light of such variations, the skilled addressee would understand that other similar means of removably connecting the cap portion 136 to the head portion 138 in a way that facilitate a water and dirt proof housing would fall within the scope of the invention as described and defined in the claims.

Referring to FIG. 12, said figure shows a cross section of the wear monitoring unit 60 that includes the head portion 332 and cap portion 338 as discussed above in relation to FIGS. 11A to 11C. In an embodiment, the head portion 332 may be shaped to form a recess arranged to retain at least one battery, where the at least one battery is a power source for the wear monitoring unit 60. As shown in FIG. 12, the recess may be arranged to retain two batteries 344. The head portion 332 may also include a hollow protrusion 346, having a first end 348 and a second end 355. The first end 348 of the hollow protrusion 346 protrudes upwards from the floor of the head portion 332 into the recess, where the first end 348 of the hollow protrusion 346 is received within a void formed between the two batteries 344 and proximate to the processing module 334.

The first end 348 of the hollow protrusion 346 may be formed with an aperture that enables access to an interior 352 formed within the hollow protrusion 346. The hollow protrusion 346 may be arranged to extend past the head portion 332 and into the neck portion 338, such that the second end 355 of the hollow protrusion 346 is distally located with respect to the batteries 344 and the processing module 334. The second end 355 of the hollow protrusion 346 is formed with an opening having the same diameter as the diameter of the interior 352.

The processing module 334 is shown in FIG. 12 as a single printed circuit board (PCB) board. However, the module 334 may also be made from more than one PCB board. The PCB board(s) may include various components and circuitry that enables the board(s) to operate according to the processing system 100 described above to perform the role of the wear monitoring unit 60.

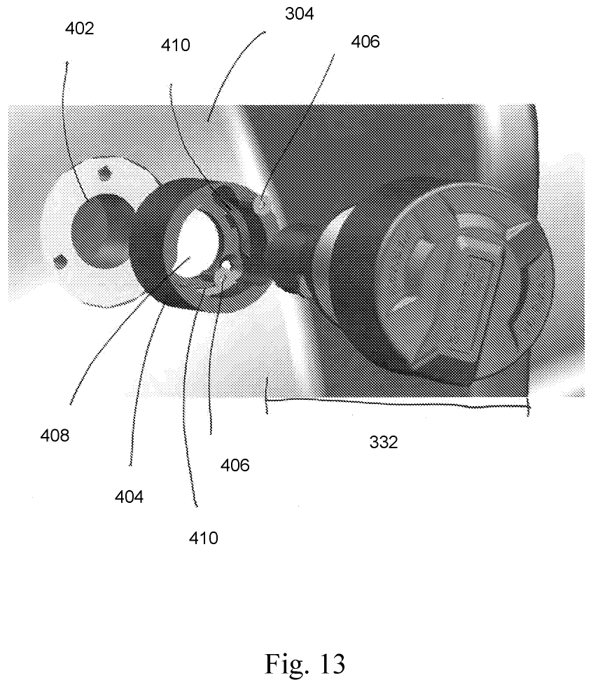

Referring now to FIG. 13, an embodiment is described where the head portion 332 includes a connector portion 404 arranged to connect to the outer casing 304. The neck 338 of the head portion 332 may be removably connected to the connector portion 404 to enable communication cabling from the antenna 20 to pass through the outer casing 304 of the pump and connect to the wear monitoring unit 60. An aperture 402 may be formed to extend through the outer casing 304. The connector portion 404 may be fastened to the outer casing 304 by means of screws 406 or similar fastening devices that enable a robust and tight connection. The connector portion 404 may be arranged such that an aperture 408 formed in the connector portion 404 aligns with the aperture 402 formed in the outer casing 304. The neck portion 338 may be received and retained within the aperture 402 and aperture 408. The neck portion 338 and the connector portion 404 may each include respective connective cammed surfaces that engage with one another to removably connect the neck portion 338 to the connector portion 404. For example, the connector portion 404 and the neck portion 338 may connect together using a bayonet connection 410.

In an embodiment, the bayonet connection 410 may incorporate electrical contacts through which the antennas 20 and the wear monitoring unit 60 may communicate. In such an arrangement, the connector portion 404 may receive a cable (not shown) from the antennas 20 or the antenna hub. When the head portion 332 is inserted into the connector portion 404, the electrical contacts on the neck portion 338 and the connector portion 404 mate to allow signals to pass from the antenna 20 to the wear monitoring unit 60. The use of bayonet connection 410 incorporating electrical contacts allows for easier removal and installation of wear monitoring unit 60 during operation of the pump without needing to rewire flying leads from the antennas 20 to the wear monitoring unit 60.

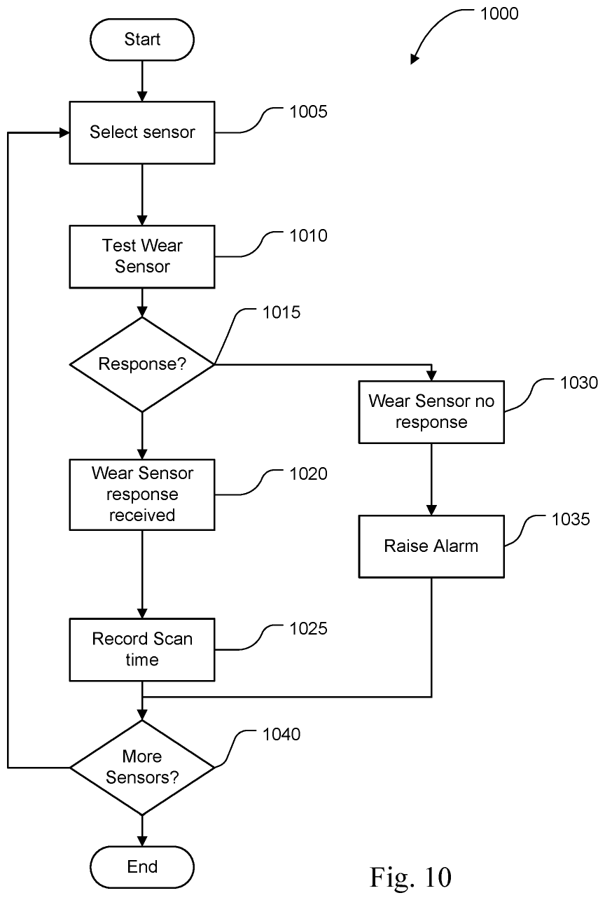

In an embodiment, a method for detecting wear using the wear sensing system 1 maybe provided. Referring to the flow diagram of FIG. 10, a wear monitoring method 1000 of detecting wear is described. The method 1000 may be implemented as software stored on the storage device 114 and executed by the processor 102 of the processing system 100. The method 1000 may be performed by the wear monitoring unit 60 when monitoring the wear of a main liner 308 or any other pump liner.

The method 1000 performs a test for each of the wear sensors 10 to determine if the wear sensors 10 are responsive or nonresponsive to the antennas 20. The method 1000 may be performed at a regular interval that is determined by considering a number of factors. For example, one factor may be an expected rate of wear of the pump liner, as a slow wearing pump liner will not be required to be checked as often as a faster wearing pump liner. Further factors may include power considerations. For example, if the wear monitoring unit 60 is operated by a finite battery power source, power will be consumed each time a wear sensor 10 is tested.

The responses of the wear sensors 10, or lack thereof of, provides an indication of the level of wear. For example, if the wear sensors 10 do not respond to the wear monitoring unit 60, then the pump liner may be considered to have worn to the depth at which the wear sensor 10 was located. When a wear sensor 10 is nonresponsive then a notification or alarm may be provided.

In an embodiment, the method 1000 first includes a selection step 1005, where a wear sensor 10 is selected for testing from a list of possible wear sensors 10. Each wear sensor 10 may be polled and selected in sequence, where being polled describes an arrangement where the wear sensors 10 wait for the wear monitoring unit 60 to check the wear sensors 10 readiness state. Alternatively, only operational wear sensors may be selected for testing, or when the pump liner is new, all wear sensors will be tested.

As the pump liner wears and wear sensors become nonresponsive the number of wear sensors tested may decrease. Alternatively, the wear monitoring unit 60 may select wear sensors 10 according to their depth. In such an embodiment, for a selected monitoring site, operational wear sensors 10 will be tested in a depth order. If the wear sensor 10 closest to the inner surface is determined to be operational, then wear sensors located deeper in the pump lining, further from the inner or wear surface, will not be tested. However, if the wear sensor 10 closest to the inner surface is nonresponsive or not operational, then the next closest wear sensor 10 will be selected for testing. The wear sensors 10 will then be selected in depth order as the inner surface of the pump lining wears. Selecting a subset of the wear sensors 10 may allow power savings for the wear monitoring unit 60 if the wear monitoring unit 60 is battery powered.

The method 1000 may further include a test step 1010, wherein the selected wear sensor is tested. As discussed above, the wear sensor 10 is tested by transmitting a pulse from the antenna. The pulse is picked up by the wear sensor 10 and a return pulse is transmitted by the wear sensor 10 to the antenna module 20. The return pulse is then transmitted via the antenna wires 40 and to the wear monitoring unit 60. When this occurs the wear sensor 10 is considered to be active and responsive. However, if the return pulse is not received by the wear monitoring unit 60 within a suitable time out period, then the wear sensor 10 has not responded and is then considered to be nonresponsive.

A response check step 1015 branches the operation of the method 1000 depending on the response of the wear sensor 10. If a response is received from the wear sensor 10 then the method 1000 proceeds to a response received step 1020. At the response received step 1020 the status of the test wear monitor 10 is updated and stored on storage device, such as the storage device 114.

Next, an optional time recording step 1025 may occur where a time of response for the wear sensor 10 is recorded in the storage device 114 of the wear monitoring unit 60. The time recording step 1025 allows the wear monitoring unit to determine when a last response was received from the wear sensor 10. The last response time may be used to determine a rate of wear for the monitoring location in the pump liner. The rate of wear may be determined using the depth of the wear monitor along with the last response time and the run hours of the pump. Alternatively, a difference of depth between two wear sensors, combined with an interval between the last response time for the two wear sensors is used to determine a rate of wear. The rate of wear may also be calculated using run hours of the pump if the pump was not in use for all of the interval.

The method may further include the step where, if a response from the wear sensor 10 is not received, then the response check step 1015 proceeds to the no response step 1030. An update of an operational status of the wear sensor 10 may occur. Alternatively, the wear monitoring unit 60 may require that the wear sensor 10 is nonresponsive for more than one test. For example, the wear sensor 10 may need to be nonresponsive for three successive test steps before the operational status of the wear sensor 10 is updated. Once the method 1000 determines that the wear sensor 10 is nonresponsive the status of the test wear monitor 10 is updated and stored on the storage device 114.

In an embodiment, the method 1000 may further include the step of executing an optional alarm raising step 1035 if the operational status of the wear sensor 10 is updated to nonresponsive. An alarm may be raised by changing a status of the local status display. Alternatively, or additionally, the alarm may be raised by the wear monitoring unit 60 communicating with a further device such as a mobile phone or a networked computer by notify monitoring software module executing on the further device.

In yet another embodiment, the method 1000 includes the step of proceeding to a more sensors check 1040. This involves a check to determine whether there are any more wear sensors to be tested. If there are no more sensors to check then the method 1000 terminates. In an embodiment, the further device may in communication with the wear monitoring unit 60 may be configured to automatically cease the operation of the pump in the event that no more sensors are detected. This may be provided to prevent damage to prevent damage to the pump if the pump liners have worn too thin. If there are more wear sensors to check, the method 1000 returns to the select sensor step 1005 where a new wear sensor is selected for testing.

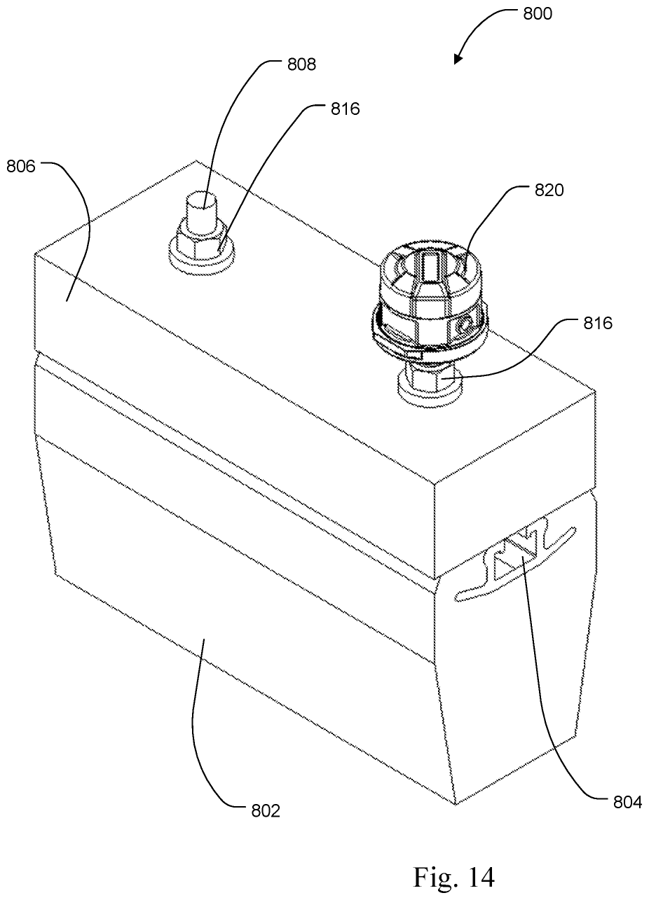

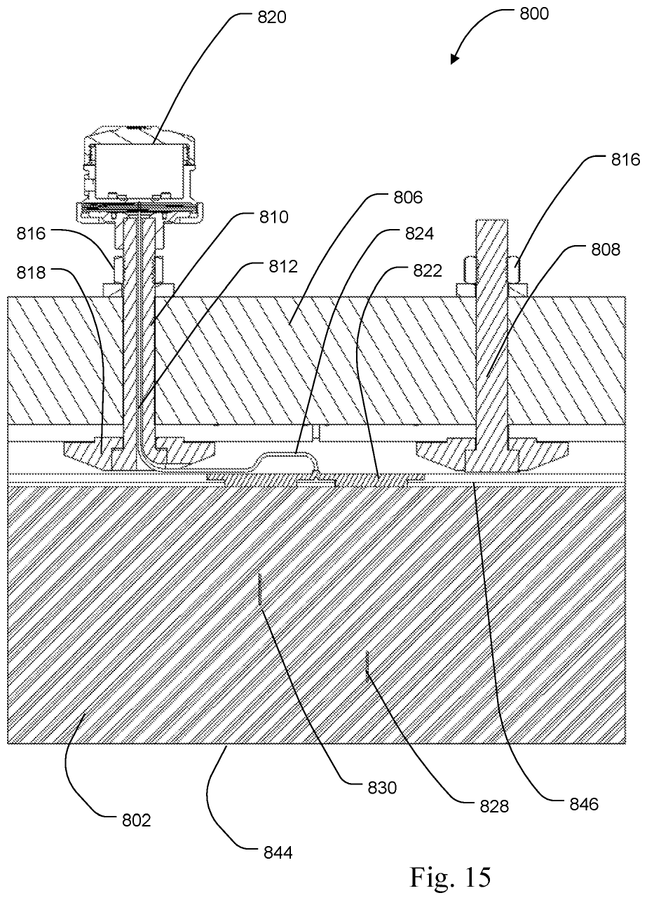

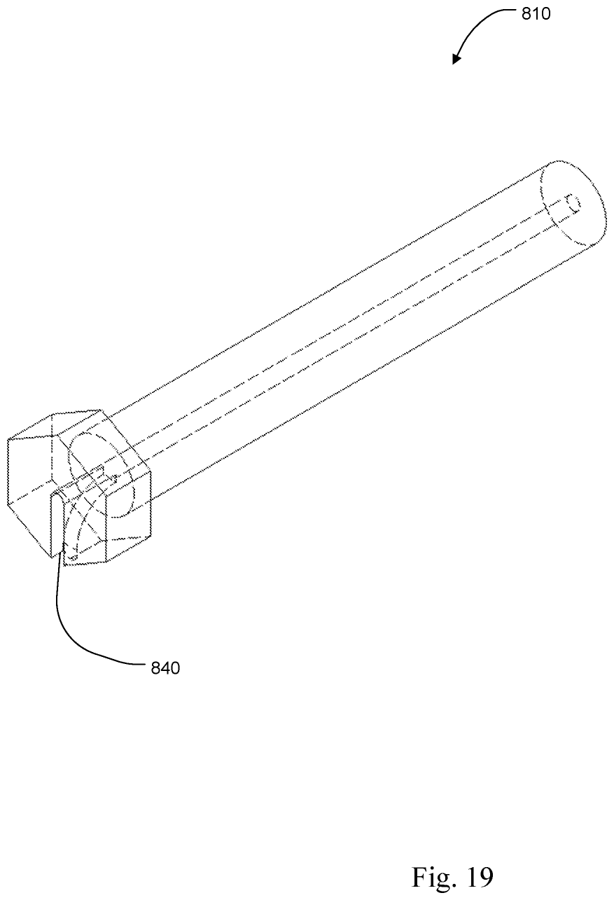

An alternative embodiment will now be described in relation to FIGS. 14 to 19 which show a wear part, a lifter bar, which may be used on a mill. Sacrificial wear sensors are embedded at known predetermined depths along an axial length of the lifter bar. Wear is estimated when at least one sacrificial wear sensor, at a known depth, is nonresponsive to the wear monitoring unit. Further wear progression is estimated as additional sacrificial wear sensors at known progressive depths are unresponsive to the wear monitoring unit. Communication between the sacrificial sensors and the wear monitoring units may be via a low frequency radio frequency identification (RFID) using an antenna.

A lifter bar assembly 800 contains an embodied mounting rail 804, made from aluminium or steel, for the purpose of fastening a lifter bar 802 into position against a mill shell 806. The embodied mounting rail 804 has rail pockets 826 into which one or more antenna 822 are positioned. Antenna wiring 824 is routed to a wear monitoring unit 820 via a vented lifter liner fastening bolt 810 which has the wear monitoring unit 820 screwed onto a threaded end of vented lifter liner fastening bolt 810. The antenna wiring 824 may be detachably connected to the wear monitoring unit 820. A head of the vented lifter liner fastening bolt 810 is located in an attachment rail 834 with the threaded end of the vented lifter liner fastening bolt 810 passing though the mill shell 806 and held by a fastening nut 816. The vented lifter liner fastening bolt 810 has a wiring passage 812 that allows passage of the antenna wiring 824, with an antenna cable slot 840 providing a suitable bend radius for the antenna wiring 824 to change direction and run along the attachment rail 834 to the antenna 822. Additional bolts may also be used to attach the lifter bar 802 to the mill shell 806, such as a lifter liner fastening bolt 808. The lifter liner fastening bolt 808 may be used when there is no antenna cable to pass through the mill shell 806. The lifter liner fastening bolt 808 is tightened with a fastening nut 816. The lifter bar 802 may be bolted to the mill shell 806 using the lifter liner fastening bolt 808 and vented lifter liner fastening bolt 810.

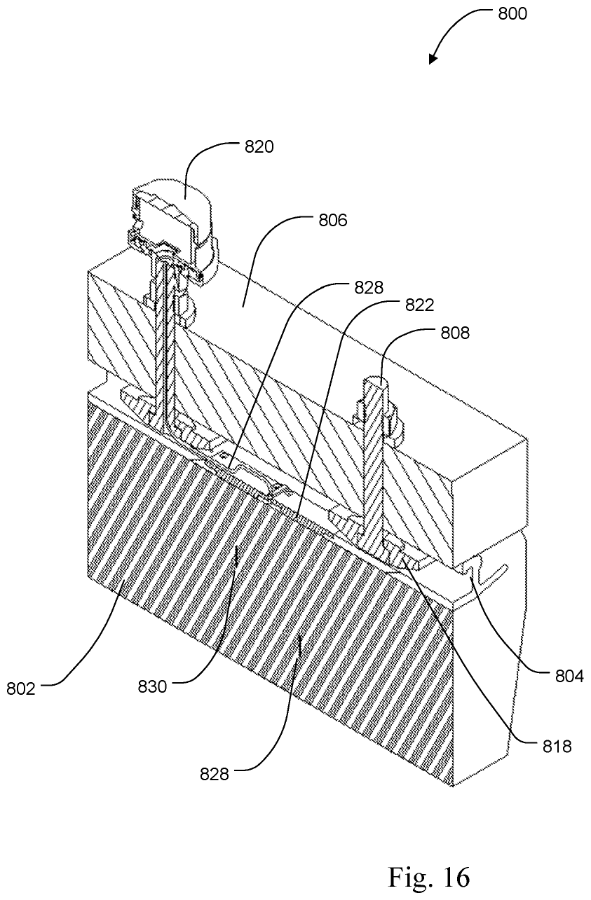

The heads of the vented lifter liner fastening bolt 810 and the lifter liner fastening bolt 808 slot into the attachment rail 834. As shown in FIG. 16, the bolts may use a bolt head retainer 818 to prevent rotation of the bolts when the fastening nuts 816 are tightened. The bolt head retainer 818 may also distribute the force of the bolt head on the embodied mounting rail 804. The embodied mounting rail 804 has a mounting rail flange 832 that holds the lifter bar 802 to the embodied mounting rail 804.

Embedded in the lifter bar 802 are an initial wear sensor 828 and a further wear sensor 830 that wirelessly communicate with the wear monitoring unit 820 via the antenna 822 using wireless communication. The initial wear sensor 828 is located closer to an inner surface 844, which may also be referred to as a wear surface, while the further wear sensor 830 is located closer to an outer surface 846. Each of the wear sensor is positioned a predetermined distance between the inner surface 844 and the outer surface 846. The antenna 822 sits in rail pockets 826 of the embodied mounting rail 804 at the outer surface 846. The rail pockets 826 allow communication between the antenna 822 and the wear sensors as wireless signals, such as used for RFID, cannot typically pass through metal. The rail pockets 826 also accurately positions the antenna 822 to align with the wear sensors.

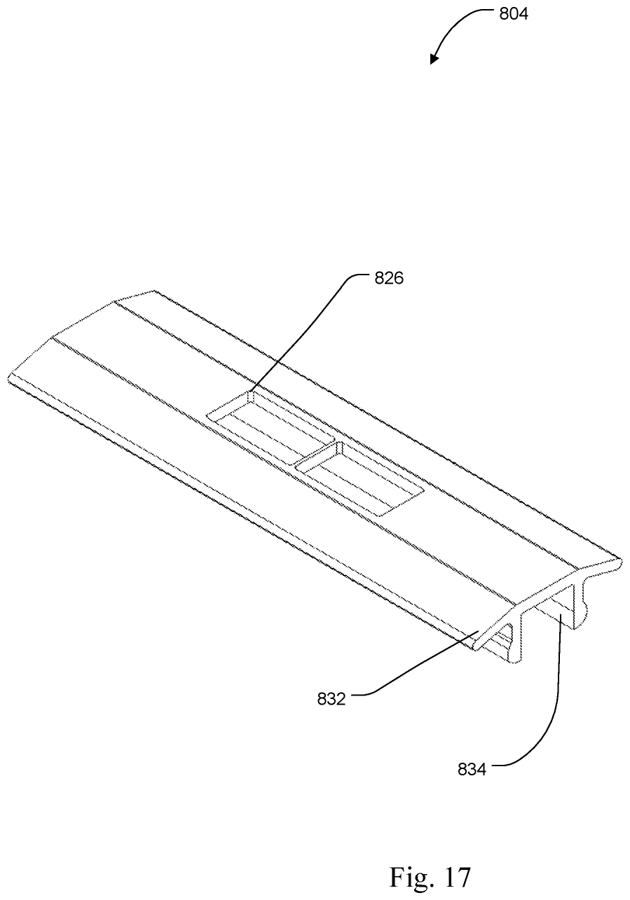

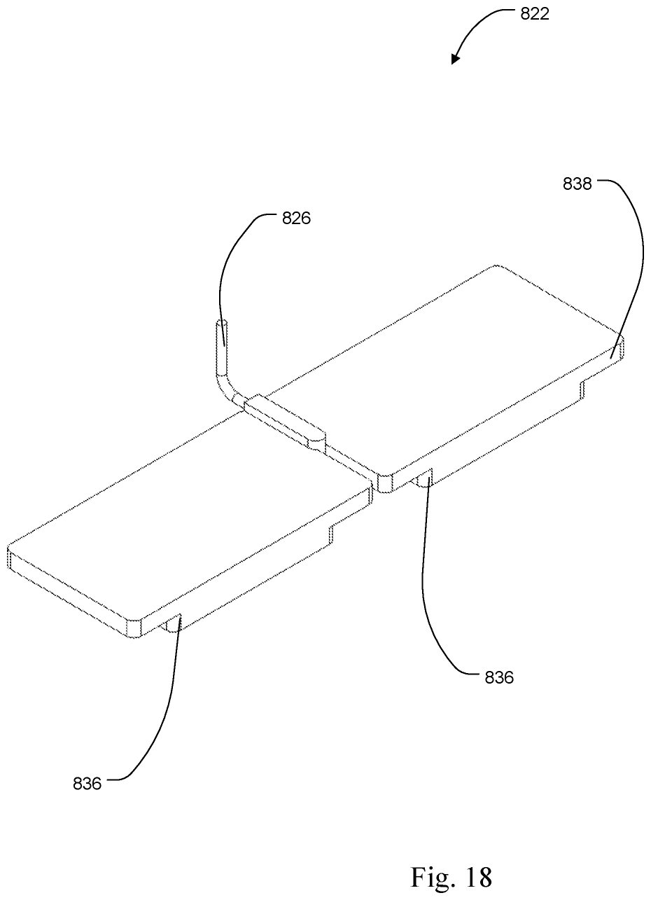

The embodied mounting rail 804 may be extruded with the rail pockets 826 machined into one surface. As shown in FIG. 17, the rail pockets 826 are rectangular. However a directional shape may also be used, such as having one corner of each hole of the rail pockets 826 chamfered. As seen in FIG. 18, the antenna 822 has antenna pocket regions 836 with a shape corresponding to the rail pockets 826 while an antenna flange 838 prevents the antenna 822 falling through the rail pockets 826.

While the lifter bar assembly 800 is shown with two wear sensor, other numbers of sensors may also be used. For example, there may be only one wear sensor or more than two wear sensors. The wear sensor may be located at different depths, to determine wear progress or may have two or more wear sensors at the same depth to provide redundancy.

The lifter bar 802 is embedded with the initial wear sensor 828 and the further wear sensor 830, each of the wear sensors may include a transducer positioned in the lifter bar at a pre-set depth from a base of the lifter. The pre-set depth is determined by a predetermined distance of the initial wear sensor 828 or the further wear sensor 830 between the base of the lifter and the outer surface of the lifter. The wear sensors may be embedded into the lifter bar 802 in a manner dependent on a material the lifter bar 802 is made from. For example, if the lifter bar 802 is made of an elastomer material, then the wear sensor may be injected from either the outer surface of the base of the lifter bar 802. Alternatively, a wear sensor may be embedded in the lifter bar 802 during the forming process. The wear sensors are of a size that allows them to be injection into a lifter bar with a depth of the injection setting the wear sensor depth.

Wear sensors, such as the initial wear sensor 828 and the further wear sensor 830, are placed at monitoring location in a lifter bar, or bars, that are expected to have a higher wear rate during operation of the grinding mill. For example, one of more wear sensors may be positioned at each of the feed head, middle of the mill shell and discharge head. Each location may have one ore more wear monitoring units collecting information from wear sensors and transmitting the information for collection by a monitoring software module executing on a computer, such as the processing system 100. The wear monitoring units rotate as the mill rotates, making fixed power wires to the wear monitoring units inconvenient. As the wear monitoring units transmit wirelessly the units may be powered by an internal battery for wire free operation. If more than one wear sensor is placed at a monitoring location, then the additional wear sensors may provide redundancy, may be used to determine different amounts of wear, or a combination of the two. To determine different amounts of wear at a monitoring location, wear sensors may be placed at different pre-set depths. An initial amount of wear is detected when the wear sensor closest to the lifter bar surface does not respond to a signal from the antenna module. As such, wear sensors located with increasing pre-set depths provide a measure of increasing wear of the lifter bar at the monitoring location.

Through wireless transmission of the wear sensor responsiveness the monitoring system allows estimated wear of the lifter bars to be gathered without the need to stop rotation of the mill and provides wear monitoring during operation of the mill. Monitoring wear during mill operation may allow the mill to have longer periods between maintenance stoppages as the wear monitoring system may provide updated information regarding the wear state of lifter bars in the mill.

The lifter bar assembly 800 described above uses the wireless wear monitoring unit 820 to provide results to a monitoring software module executing on a computer, such as the processing system 100, using a wireless communication protocol, such as wireless communication means 236 which may use IEEE 802.11Wi-Fi. An alternative embodiment may not use a fixed wear monitoring unit located on the outside of the mill shell, such as wear monitoring unit 820. Instead, sacrificial wear sensors may be located using a portable monitoring unit. In such an embodiment, a portable wear monitoring unit may be taken into a mill during a maintenance shutdown. The portable wear monitoring unit may be taken to individual lifter bars where sacrificial wear sensors are installed. The wear monitoring unit may determine if the wear sensors are still located in the lifter bar. Such an embodiment may provide a simpler lifer bar assembly, however the wear of the lifter bars can only be determined when the mill is not operating.

The wear monitoring of the lifter bar has many similar features to the wear monitoring of the pump liner described above. For example, the wear monitoring units, antenna modules, antenna wiring and wear sensors may be similar or even use the same design. The wear monitoring method 1000 of FIG. 10 may also be used for the wear monitoring of the lifter bar.

As described, above in relation to the centrifugal pump liner and the lifter bar, an RFID transponder may be used as a sacrificial wear sensor to monitor wear of minerals processing equipment. When using a wear sensor operating on a single frequency, such as a low frequency RFID tag operating, wear sensors must be spaced apart to prevent interference. In one embodiment, an antenna for the RFID tag, such as antenna 20 shown in FIG. 9B, may be a 40 mm square with the wear sensors having a minimum spacing of 70 mm. Such antennas may have a detection cone of 30 degrees. Multiple RFID tags may be positioned closer than 70 mm apart if anti-collision is used.

In current RFID systems, anti-collision exists for high frequency and ultra-high frequency RFID tags, but not for low frequency RFID tags. In one embodiment, anti-collision may be used with low frequency (LF) RFID tags which operate in a frequency range of 30 kHz to 300 kHz. This may be carried out using RFID tags operating at identifiably different frequencies, for example, 125 kHz and 134 kHz, and a single antenna module configured to detect the two different frequencies. Such an arrangement allows two RFID tags to be read by the antenna module and allows the two RFID tags to be closely located, without any need for separation. The two tags may even be stacked or in line, one on top of the other, from the perspective of the antenna. Such an arrangement allows for multiple wear sensors to be detected by a single antenna module and operate in a many to one arrangement. Multiple sensor may then be used to provide redundancy or progressive wear measurements, such as 50% and 70% wear of the component.

The wear sensors used for the centrifugal pump liner and the lifter bar may be positioned by injecting the wear sensor. Injection of a wear sensor is possible for a material such as an elastomer and allows the wear sensor to be inserted into the item at a predetermined depth within the elastomeric material. Injection of wear sensors may be advantageous over other techniques as the wear sensor is surrounded by the liner or lifter bar material with minimal structural degradation of the elastomer from the insertion. As such, the wear sensors may be considered to be integrated into the centrifugal pump liner or lifter bar in which they are placed. An injected wear sensor may be compared to a wear sensor housed in a comparatively large sensor module that is attached or inserted into a cavity for wear detection. The sensor module may be constructed of a different material to the pump liner or lifter bar that wears at a different rate. The introduction of a cavity for the large sensor module may also alter the mechanical properties, such as wear resistance or strength, of the pump liner or lifter bar in which the large sensor module is mounted.

In the foregoing description of preferred embodiments, specific terminology has been resorted to for the sake of clarity. However, the invention is not intended to be limited to the specific terms so selected, and it is to be understood that each specific term includes all technical equivalents which operate in a similar manner to accomplish a similar technical purpose. Terms such as “front” and “rear”, “above” and “below” and the like are used as words of convenience to provide reference points and are not to be construed as limiting terms.

Optional embodiments may also be said to broadly include the parts, elements, steps and/or features referred to or indicated herein, individually or in any combination of two or more of the parts, elements, steps and/or features, and wherein specific integers are mentioned which have known equivalents in the art to which the invention relates, such known equivalents are deemed to be incorporated herein as if individually set forth.

Although a preferred embodiment has been described in detail, it should be understood that modifications, changes, substitutions or alterations will be apparent to those skilled in the art without departing from the scope of the present invention.

Throughout this specification and the claims which follow, unless the context requires otherwise, the word “comprise”, and variations such as “comprised”, “comprises” or “comprising”, will be understood to imply the inclusion of a stated integer or step or group of integers or steps but not the exclusion of any other integer or step or group of integers or steps.

As used herein, a, an, the, at least one, and one or more are used interchangeably, and refer to one or to more than one (i.e. at least one) of the grammatical object. By way of example, “an element” means one element, at least one element, or one or more elements.

In the context of this specification, the term “about” is understood to refer to a range of numbers that a person of skill in the art would consider equivalent to the recited value in the context of achieving the same function or result.

### ADVANTAGES

The embodiments described herein provide a novel means of detecting wear in a minerals processing equipment, such as centrifugal pump or mill. The embodiments as described provides unsurpassed level of information on the operation and wear of the internal operation of the pump. That is, the present invention detects the overall level of wear, localised pockets of wear and the rate of wear of the pump liners.

Further, by ceasing operation of the minerals processing equipment, such as a pump or mill, if the pump liners or mill lifter bars are detected as being too thin, the method provides a fail safe system that may stop operation of the pump prior or mill to failure of the liners.

Moreover, increased reliability of the system is provided by the ability to arrange multiple wear sensors together. Further, the number of sensors and their relative arrangements to one another provides higher accuracy as to the level of wear and rate of wear compared to current sensing methods and devices.

Further, the embodiments described provide varied means of manufacture. That is, the system may be formed integrally with the pump liners or mill lifter bars, or may be retrofitted to current pump liners or pill lifter bars. When sensors are located in the minerals processing equipment, such as pump liners or mill lifter bars, during manufacturing, the minerals processing equipment may be installed on site and the wear sensor will be recognized by the wear monitoring system. This may result in no additional work required to install a pump liner or lifter bar fitted with a wear sensor compared to a pump liner or mill liner bar without wear sensors.

1. A wear part for minerals processing equipment, the wear part comprising:
an inner surface for contact with slurry when the minerals processing equipment is in use;
an outer surface of the wear part; and
at least one sacrificial wear sensor injected into the wear part at a predetermined distance between the inner surface and the outer surface, the at least one sacrificial wear sensor being arranged to wirelessly communicate with a remote wear monitoring unit, the sacrificial wear sensor indicating wear when nonresponsive to wireless communication from the wear monitoring unit.

2. The wear part according to claim 1, wherein the wear part is a pump liner for a centrifugal slurry pump.

3. The wear part according to claim 1, wherein the wear part is a lifter bar for a mill.

4-6. (canceled)

7. The wear part according to claim 1, wherein the at least one wear sensor is two wear sensors and the two wear sensors are in line from the antenna and configured to operate at identifiably different frequencies from each other.

8-13. (canceled)

14. The pump liner according to claim 2, wherein the at least one wear sensor is located near a cutwater.

15. (canceled)

16. The wear part according to claim 1 further comprising:
an additional sacrificial wear sensor located at a further predetermined distance between the inner surface and the outer surface and able to communicate with a wear monitoring unit.

17. The wear part according to claim 16, wherein the further predetermined distance of the additional sacrificial wear sensor is different to the predetermined distance of the at least one sacrificial wear sensor.

18. (canceled)

19. A method of estimating wear in a wear part of minerals processing equipment, the method comprising:
determining, via a wear monitoring unit, an operational status of at least one sacrificial wear sensor injected into the wear part at a predetermined distance between an inner surface and an outer surface of the wear part, the at least one sacrificial wear sensor wirelessly communicating with the wear monitoring unit; and
estimating wear in the wear part according to the determined operational status of the at least one sacrificial wear sensor, the sacrificial wear sensor indicating wear when nonresponsive to wireless communication from the wear monitoring unit.

20-21. (canceled)

22. The method according to claim 19, wherein the wear monitoring unit is connected to an antenna and the at least one sacrificial wear sensor wirelessly communicates with the wear monitoring unit via the antenna.

23. The method according to claim 22, wherein the at least one wear sensor is two wear sensors and the two wear sensors are in line from the antenna and configured to operate at identifiably different frequencies from each other.

24. (canceled)

25. The method according to claim 19, wherein a nonresponsive status of the operational status indicates wear of the wear part to at least the predetermined distance between the inner and the outer surface of the wear part.

26. The method according to claim 19, further comprising:
determining, via a wear monitoring unit, an operational status of an additional sacrificial wear sensor located at a further predetermined distance between the inner surface and the outer surface, the further predetermined distance being different to the predetermined distance of the at least one sacrificial wear sensor.

27. The method according to claim 26, wherein the wear in the wear part is estimated according to an operational status of the additional sacrificial wear sensor.

28. The method according to claim 27, wherein the wear in the wear part is estimated according to a wear distance selected from the set of the predetermined distance of the at least one sacrificial wear sensor and the further predetermined distance of the additional sacrificial wear sensor according to the operational status of the at least one sacrificial wear sensor and the additional sacrificial wear sensor.

29. The method according to claim 26, wherein the at least one sacrificial wear sensor and the additional sacrificial wear sensor are RFID transducers with spatial separation to reduce interference between each sensor.

30-31. (canceled)

32. A system for determining wear of a wear part for minerals processing equipment, the system comprising:
at least one sacrificial wear sensor injected into the wear part at a predetermined distance between an inner surface and an outer surface of the wear part; and
a wear monitoring unit adapted to wirelessly communicate with the at least one sacrificial wear sensor for determining wear of the wear part from an operational status of the at least one sacrificial wear sensor when the at least one sacrificial wear sensor is nonresponsive to wireless communication from the wear monitoring unit.

33-35. (canceled)

36. The system according to claim 32 further comprising:
an additional sacrificial wear sensor located at a further predetermined distance between the inner surface and the outer surface and able to communicate with a wear monitoring unit.

37. The system according to claim 36, wherein the further predetermined distance of the additional sacrificial wear sensor is different to the predetermined distance of the at least one sacrificial wear sensor.

38-40. (canceled)

41. The system according to claim 32, wherein the wear monitoring unit is connected to an antenna and the at least one sacrificial wear sensor wirelessly communicates with the wear monitoring unit via the antenna.

42. The system according to claim 41, wherein the at least one wear sensor is two wear sensors and the two wear sensors are in line from the antenna and configured to operate at identifiably different frequencies from each other.

43. (canceled)
